(19) United States
(12) Patent Application Publication
(10) Pub. No.: US 2016/0056888 A1
(43) Pub. Date: Feb. 25, 2016

(54) Active and Standby Changeover Method, Apparatus, Device, and System for Network Device

(71) Applicant: ZTE CORPORATION, Shenzhen City, Guangdong Province (CN)

(72) Inventors: Li SUN, Shenzhen (CN); Rihong WANG, Shenzhen (CN); Hongwei ZHANG, Shenzhen (CN)

(73) Assignee: ZTE CORPORATION, Shenzhen City, Guangdong Province (CN)

(21) Appl. No.: 14/783,424

(22) PCT Filed: Apr. 9, 2014
(86) PCT No.: PCT/CN2014/074982

§ 371 Date: Oct. 8, 2015

(30) Foreign Application Priority Data
Apr. 24, 2013 (CN) 201310145157.9

(51) Int. Cl. H04B 10/038

(52) U.S. Cl. CPC H04B 10/038

(57) ABSTRACT

A main and standby switchover method, apparatus, device, and system for a network device relate to the technical field of wireless networks. The method includes: receiving an interrupt signal indicating that a switchover needs to be performed for main and standby GE ports; performing a switching operation of the main and standby GE ports, setting the main GE port in a blocked state, and in the blocked state, the main GE port only forwarding a bridge protocol data unit (BPDU) message, and stopping learning a MAC address; and enabling the standby GE port, setting the standby GE port in a forwarding state, and in the forwarding state, the standby GE port forwarding messages of all types, and learning the MAC address.

### TECHNICAL FIELD

The present document relates to the wireless network field, and in particular, to a main and standby switchover method, apparatus, device, and system for a network device.

### BACKGROUND OF THE RELATED ART

Along with the increasing mature of the optical access network technology, the optical fiber will replace the copper line as the predominant access method. As shown in FIG. 1, an Optical Network Unit (ONU) is set in the corridor of the general residence, which is connected with the Optical Line Terminal (OLT) in the uplink direction through the PON port, and one OLT is responsible for the data transmission of multiple ONUs. Wherein, the Gigabit Ethernet (GE) port in the ONU divides the data and then sends the data to the user in the corridor for using through a Fast Ethernet (FE) port (100-megabit port) (as the PC shown in FIG. 1).

In order to satisfy the disaster tolerance requirement, the main GE port and the standby GE port are set in the optical node ONU. When the main GE port fails, the ONU performs the main and standby switchover of the GE ports. The main and standby switchover of the GE ports is realized by adopting the port isolation method in the related art, that is, after the main GE port is switched to the standby GE port, the isolations are set to isolate main GE port from the standby GE port and isolate the main GE port from all FE ports. Therefore, there are several following problems in the related art:

1, along with the increasing quantity of the ONU ports, setting the isolation time between the ports is caused to be longer, therefore, the switchover time is also extended, which is difficult to satisfy the requirement of the fast switchover.

2, the isolation protection is not performed between the CPU in the ONU in the related isolation method and the standby GE port (as shown in FIG. 1), which causes that the message incoming from the CPU (such as the ping packet) will be sent to all GE ports, and the main and standby PON ports also will send the two same messages, therefore, it is unable to satisfy the hand-in-hand double-link protection requirement of the electricity EPON standard; details refer to FIG. 2.

Note: for the hand-in-hand double-link protection (as shown in FIG. 2), every ONU is connected with 2 OLTs respectively, and it is required that, except the management message between the ONU and the OLT, all other service messages are only received and sent in one direction in any time.

### SUMMARY OF THE INVENTION

The technical problem that the present document requires to solve is to provide a main and standby switchover method, apparatus, device and system for a network device, which can realize the rapid completion of the main and standby GE ports, and satisfies the hand-in-hand double-link protection requirement of the electricity EPON standard at the same time.

In order to solve the above technical problem, the embodiment of the present invention provides a main and standby switchover method for a network device, comprising:

receiving an interrupt signal indicating that a switchover needs to be performed for main and standby Gigabit Ethernet (GE) ports;

performing a switching operation of the main and standby GE ports, setting the main GE port in a blocked state, and in the blocked state, the main GE port only forwarding a bridge protocol data unit (BPDU) message, and stopping learning an MAC address; and

enabling the standby GE port, setting the standby GE port in a forwarding state, and in the forwarding state, the standby GE port forwarding messages of all types, and learning the MAC address.

Wherein, the step of setting the main GE port in a blocked state comprises:

setting a spanning tree protocol (STP) of the main GE port as a block mode, and enabling the main GE port to enter the blocked state; and

the step of setting a STP of the standby GE port as a forwarding state comprises: setting the STP of the main GE port as a forwarding mode, and enabling the main GE port to enter the forwarding state.

Wherein, after setting a STP of the main GE port as a blocked state, the method further comprises:

deleting all dynamic MAC addresses learnt by the main GE port.

The embodiment of the present invention further provides a main and standby switchover apparatus for a network device, comprising:

a receiving unit, configured to: receive an interrupt signal indicating that a switchover needs to be performed for main and standby Gigabit Ethernet (GE) ports;

a first setting unit, configured to: set the main GE port in a blocked state, and in the blocked state, the main GE port only forwards a bridge protocol data unit (BPDU) message, and stops learning a MAC address; and

a second setting unit, configured to: enable a standby GE port, and set the standby GE port in a forwarding state, and in the forwarding state, the standby GE port forwards messages of all types, and learns the MAC address.

Wherein, the first setting unit is configured to: set a STP of the main GE port as a block mode, and enable the main GE port to enter the blocked state;

the second setting unit is configured to: set the STP of the main GE port as a forwarding mode, and enable the main GE port to enter the forwarding state.

Wherein, the apparatus of the present embodiment further comprises:

a deleting unit, configured to: delete all dynamic MAC addresses learnt by the main GE port after the first setting unit sets the STP of the main GE port as the blocked state.

The embodiment of the present invention further provides an optical network unit (ONU) device, comprising a main GE port, a standby GE port and a CPU; wherein the device of the present embodiment further comprises:

a detection module, configured to: detect state information of the main GE port, and send an interrupt signal indicating that a switchover needs to be performed for main and standby GE ports to the CPU if the switchover needs to be performed for the main and standby GE ports;

a exchanging chip, configured to: set the main GE port in a blocked state, enable the standby GE port, and set the standby GE port in a forwarding state;

the CPU is configured to: control the exchanging chip to work according to the interrupt signal;

wherein, in the blocked state, the main GE port only forwards a bridge protocol data unit (BPDU) message, and stops learning a MAC address; and in the forwarding state, the standby GE port forwards messages of all types, and learns the MAC address.

The embodiment of the present invention further provides a network access system, including the above optical network unit (ONU) device.

The above scheme of the embodiment of the present invention has the following beneficial effects.

In the method, apparatus, device and system of the embodiment of the present invention, it can set the main GE port as the blocked state when the main GE port is switched to the standby GE port, and in the blocked state, the main GE port stops learning the MAC address. There is no need to perform the port isolation for the main GE port and all the FE ports, thereby the switching time is saved; in addition, in the blocked state, the main GE port only forwards the BPDU message, which is able to avoid that the uplink OLT device receives two same non-BPDU messages from the main GE port and the standby GE port, therefore, the hand-in-hand double-link protection requirement of the electricity EPON standard is satisfied. At the same time, the standby GE port enters the forwarding state and forwards the messages of all types, and learns the MAC address, and starts the normal work after learning the MAC address, and the main and standby switchover process is completed.

### BRIEF DESCRIPTION OF DRAWINGS

FIG. 1 is a structure diagram of an ONU in the related art;

FIG. 2 is a structure diagram of a hand-in-hand double-link protection of the electricity EPON standard;

FIG. 3 is a flow chart of a main and standby switchover method for a network device in an embodiment of the present invention;

FIG. 4 is a diagram of detailed steps of a main and standby switchover method for a network device in an embodiment of the present invention;

FIG. 5 is a structure diagram of a main and standby switchover apparatus for a network device in an embodiment of the present invention;

FIG. 6 is a structure diagram of an optical network unit (ONU) device in an embodiment of the present invention;

FIG. 7 is a structure diagram of a network access system in an embodiment of the present invention.

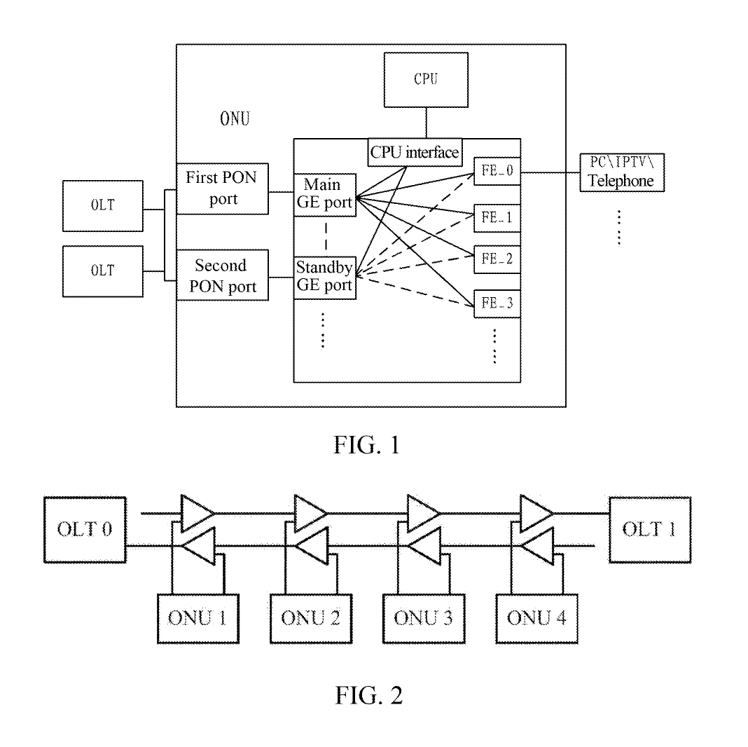

### PREFERRED EMBODIMENTS OF THE PRESENT INVENTION

It will be described in detail by combining with the accompanying drawings and the specific embodiments.

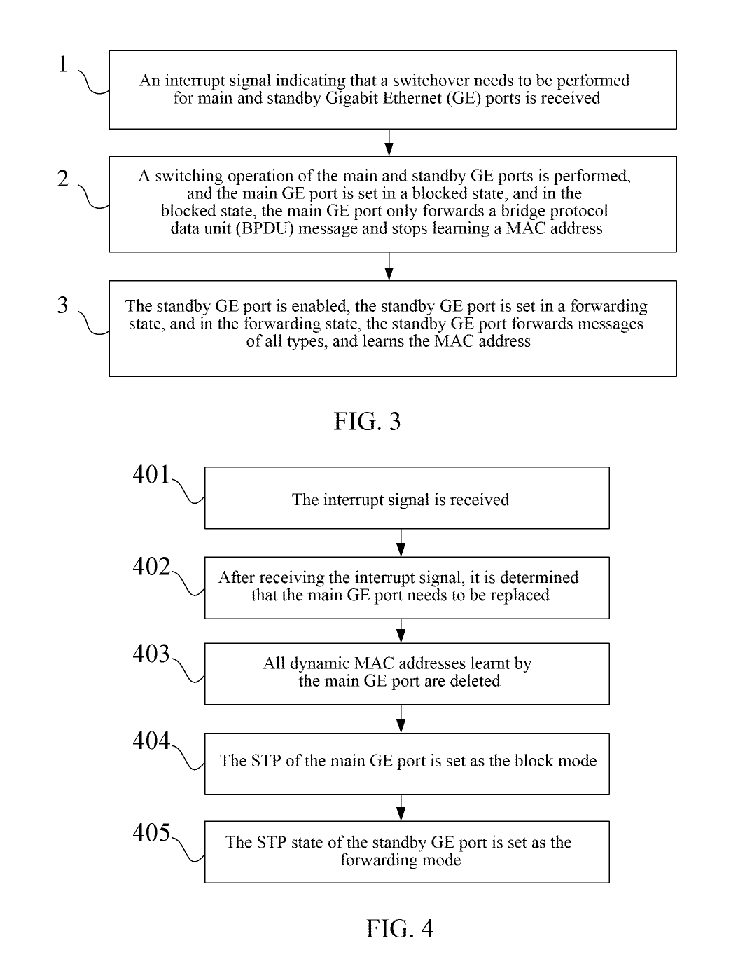

As shown in FIG. 3, a main and standby switchover method for a network device includes the following steps.

In step 1, an interrupt signal indicating that a switchover needs to be performed for main and standby Gigabit Ethernet (GE) ports is received.

In step 2, a switching operation of the main and standby GE ports is performed, and the main GE port is set in a blocked state, and in the blocked state, the main GE port only forwards a bridge protocol data unit (BPDU) message, and stops learning a MAC address.

In step 3, the standby GE port is enabled, and the standby GE port is set in a forwarding state, and in the forwarding state, the standby GE port forwards messages of all types, and learns the MAC address.

In the above method, when the main GE port is switched to the standby GE port, the main GE port is set in the blocked state, and in the blocked state, the main GE port stops learning the MAC address. There is no need to perform the port isolation for the main GE port and all the FE ports, thereby the switching time is saved; in addition, in the blocked state, the main GE port only forwards the BPDU message, which is able to avoid that the uplink OLT device receives two same non-BPDU messages from the main GE port and the standby GE port, therefore, the hand-in-hand double-link protection requirement of the electricity EPON standard is satisfied. At the same time, the standby GE port enters the forwarding state and forwards the messages of all types, and learns the MAC address, and starts the normal work after learning the MAC address, and the main and standby switchover process is completed.

In the above embodiment of the present invention, the setting the standby GE port as a forwarding state in step 2 includes:

setting the spanning tree protocol (STP) of the main GE port as the block mode, and enabling the main GE port to enter the blocked state.

The setting the standby GE port as the forwarding state in step 3 includes: setting the spanning tree protocol (STP) of the main GE port as the forwarding mode, and enabling the main GE port to enter the forwarding state.

The relevant STP includes the several following modes.

Disable: in this mode, all messages received by the port will be discarded and the message forwarding are not performed, and it is unable to learn the source MAC address of the message.

Block: in this mode, the port forwards the received BPDU message to the CPU; except the BPDU message, all other common messages will be discarded; in addition, the port cannot learn the MAC address and discards the source MAC address of the message.

Learning: in this mode, the port forwards the received BPDU message to the CPU; except the BPDU message, all other common messages will be discarded; the port learns the MAC addresses of all received messages.

Forwarding: in this mode, the port forwards the received BPDU message to the CPU; except the BPDU message, all other common messages will also be forwarded; the port learns the MAC addresses of all received messages.

Thus it can be seen that the method specifically realizes setting the states of the main and standby GE ports through changing the STP modes of the main and standby GE ports, thereby controlling forwarding the message and learning the MAC address by the GE ports.

When the main GE port, after being replaced, is restarted next time, its learnt dynamic MAC address probably has already lost its meaning. Therefore, after the STP of the main GE port is set as the blocked state in the above embodiment of the present invention, it also includes: deleting all dynamic MAC addresses learnt by the main GE port.

As shown in FIG. 4, the procedure of the main GE port switching the standby GE port is described in detail hereinafter.

In step 401, the interrupt signal is received.

In the specific realization method, it can configure an optical module and an optical link detection module for the main GE port. The optical link detection module detects the optical power reception of the optical modules respectively through the way of signaling reporting, and it will generate an alarm interrupt signal for reporting when the optical module is found to be changed (that is, the main GE port is abnormal).

In step 402, after receiving the interrupt signal, it is determined that the main GE port needs to be replaced (for example, when the main GE port is broken down).

In step 403, all dynamic MAC addresses learnt by the main GE port are deleted.

In step 404, the STP of the main GE port is set as the block mode, in the block mode, all messages except the BPDU are discarded, and the MAC address is not learnt; in that mode, it is unable to PING the OLT device through the main GE port.

In step 405, the STP state of the standby GE port is set as the FORWARD mode, in the forwarding state, the messages of all types are forwarded, and the source MAC address of the received message is learnt.

In sum, the above embodiment has several following advantages.

1, the GE port can be isolated or enter the working state through setting the STP of the GE port, therefore, the time for the main and standby switchover of the GE ports is much shorter.

2, the main GE port, after being replaced, only forwards the bridge protocol data unit (BPDU) message, while the message sent by the CPU (such as, the ping packet) is not sent from the main GE port, which avoids that the uplink OLT device receives two same messages from the main GE port and the standby GE port, and satisfies the hand-in-hand protection requirement of the electricity EPON standard.

As shown in FIG. 5, the present document further provides a main and standby switchover apparatus for a network device, including the following units.

A receiving unit is applied to receive an interrupt signal indicating that a switchover needs to be performed for main and standby GE ports.

A first setting unit sets the main GE port in a blocked state, and in the blocked state, the main GE port only forwards a bridge protocol data unit (BPDU) message, and stops learning a MAC address.

A second setting unit is applied to enable the standby GE port, and set the standby GE port in a forwarding state, and in the forwarding state, the standby GE port forwards messages of all types and learns the MAC address.

In the above apparatus, when the main GE port is switched to the standby GE port, the main GE port is set in the blocked state, and in the blocked state, the main GE port stops learning the MAC address. There is no need to perform the port isolation for the main GE port and all the FE ports, thereby the switching time is saved; in addition, in the blocked state, the main GE port only forwards the BPDU message, which is able to avoid that the uplink OLT device receives two same non-BPDU messages from the main GE port and the standby GE port, therefore, the hand-in-hand double-link protection requirement of the electricity EPON standard is satisfied. At the same time, the standby GE port enters the forwarding state and forwards the messages of all types, and learns the MAC address, and starts the normal work after learning the MAC address, and the main and standby switchover process is completed.

In the above embodiment of the present invention, the first setting unit is specifically used to: set a spanning tree protocol (STP) of the main GE port as a block mode, and enable the main GE port to enter the blocked state.

The second setting unit is specifically used to: set the STP of the main GE port as a forwarding mode, and enable the main GE port to enter the forwarding state.

The above device specifically realizes setting the states of the main and standby GE ports through changing the STP modes of the main and standby GE ports thereby controlling forwarding the message and learning the MAC address by the GE ports.

When the main GE port, after being replaced, is restarted next time, its learnt dynamic MAC address probably has already lost its meaning. Therefore, in the above embodiment of the present invention, it further includes the following units.

A deleting unit is used to delete all dynamic MAC addresses learnt by the main GE port after the first setting unit sets the STP of the main GE port as the blocked state.

Apparently, the above embodiment is an apparatus embodiment corresponding to the main and standby switchover method for a network device in the present document. The apparatus of the present embodiment also can achieve the technology effect achieved by the main and standby switchover method for the network device.

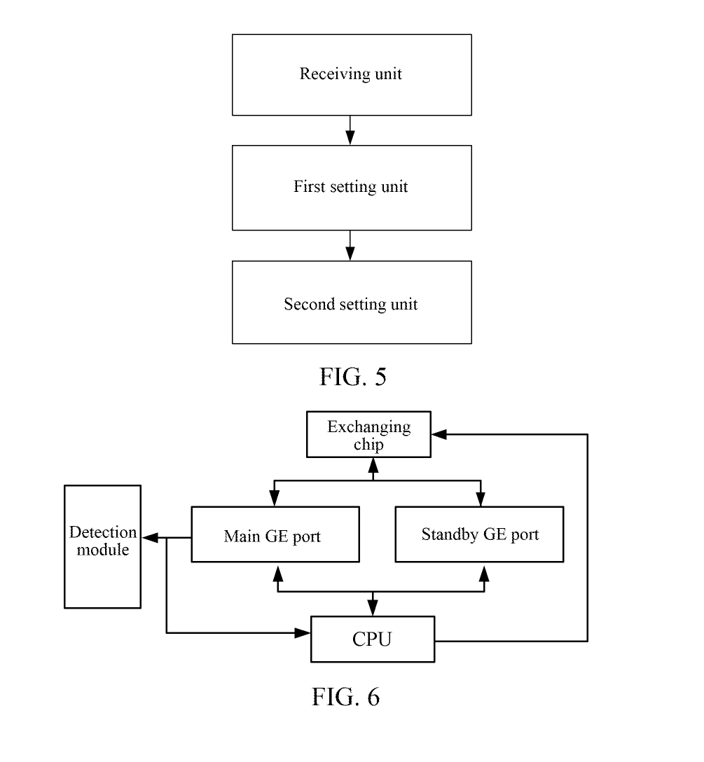

As shown in FIG. 6, the embodiment of the present invention further provides an optical network unit (ONU) device, including a main GE port, a standby GE port and a CPU; wherein the apparatus of the present embodiment further includes the following modules.

A detection module is used to detect the state information of the main GE port, and send an interrupt signal indicating that a switchover needs to be performed for main and standby GE ports to the CPU if the switchover needs to be performed for the main and standby GE ports.

An exchanging chip is used to set the main GE port in a blocked state, enable the standby GE port, and set the standby GE port in a forwarding state.

The CPU is used to: control the exchanging chip to work according to the interrupt signal.

Wherein, in the blocked state, the main GE port only forwards the BPDU message, and stops learning the MAC address; and in the forwarding state, the standby GE port forwards messages of all types, and learns the MAC address.

The exchanging chip in the above device, when the main GE port is switched to the standby GE port, sets the main GE port in the blocked state, and in the blocked state, the main GE port stops learning the MAC address. There is no need to perform the port isolation for the main GE port and all the FE ports, thereby the switching time is saved; in addition, in the blocked state, the main GE port only forwards the BPDU message, which is able to avoid that the uplink OLT device receives two same non-BPDU messages from the main GE port and the standby GE port, therefore, the hand-in-hand double-link protection requirement of the electricity EPON standard is satisfied. At the same time, the PUC sets the standby GE port in the forwarding state and enables it to forward the messages of all types, and learn the MAC address, and start the normal work after learning the MAC address.

Specifically, the CPU in the present embodiment starts the exchanging chip to work when receiving the interrupt signal sent by the detection module and determines that the main GE port is broken down. The exchanging chip starts to delete all dynamic MAC address learnt by the main GE port, and set the STP of the main GE port as the block mode (in the block mode, the main GE port discards all messages except the BPDU and does not learn the MAC address). Now the ONU is unable to PING the uplink OLT device through the main GE port. Later, the CPU sets the STP state of the standby GE port as the forwarding mode (in the forwarding mode, the standby GE port forwards the messages of all types, and learns the source MAC address of the received message).

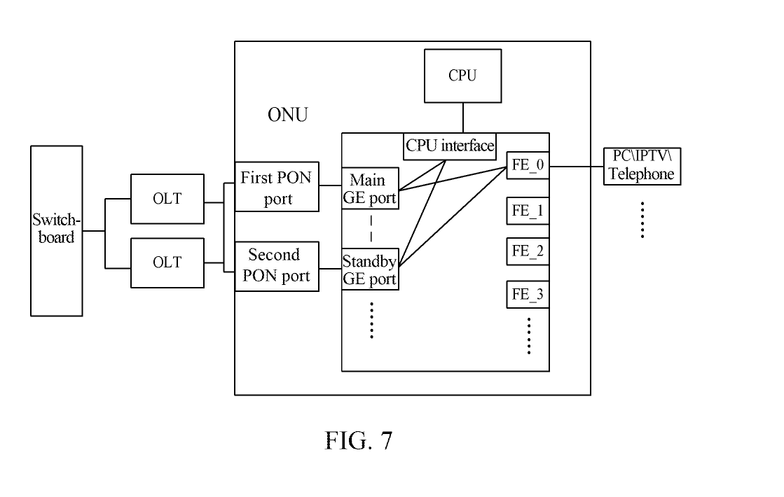

As shown in FIG. 7, the embodiment of the present invention further provides a network access system, including the above-mentioned optical network unit (ONU) device. Wherein, the PC/IPTV/Telephone used by the user is connected to the FE port of the ONU through the cable, and the ONU sends the data stream from the GE port of the ONU according to the configured forwarding rule, the GE port of the ONU is connected to the OLT through the PON port specifically, and the OLT sends out the data according to the configured forwarding rule and accesses the switchboard. In order to achieve the hand-in-hand double-link protection of the electricity EPON standard, every GE port in the ONU is connected to 2 OLTs, and at any time, all other service messages, except the management message between the ONU and the OLT, only can be received from and be sent to one OLT therein through the GE port.

The network access system of the present embodiment only forwards the BPDU message (the BPDU message is a management message) because the main GE port of the ONU is set as the blocked state after being replaced, thereby avoiding that both the main GE port and the standby GE port of ONU send the arp message to the uplink, and reducing the generation of the network storm (at present, two OLT share one cable and are connected with the switchboard in most places, in consequence, there are two OLT which learn the system MAC address of the ONU, and the switchboard receives two data streams of which both the source MAC and the target MAC are same at the same time).

The above description is the preferable embodiments of the present invention. It should be pointed out, for those skilled in the art, a plurality of modifications and retouches also can be made without departing from the described principles of the present document, and all the modifications and retouches should be embodied in the protection scope of the present document.

### INDUSTRIAL APPLICABILITY

In the method, apparatus, device and system of the embodiment of the present invention, it can set the main GE port as the blocked state when the main GE port is switched to the standby GE port, and in the blocked state, the main GE port stops learning the MAC address. There is no need to perform the port isolation for the main GE port and all the FE ports, thereby the switching time is saved; in addition, in the blocked state, the main GE port only forwards the BPDU message, which is able to avoid that the uplink OLT device receives two same non-BPDU messages from the main GE port and the standby GE port, therefore, the hand-in-hand double-link protection requirement of the electricity EPON standard is satisfied. At the same time, the standby GE port enters the forwarding state and forwards the messages of all types, and learns the MAC address, and starts the normal work after learning the MAC address, and the main and standby switchover process is completed.

What we claim is:

1. A main and standby switchover method for a network device, comprising:
receiving an interrupt signal indicating that a switchover needs to be performed for main and standby Gigabit Ethernet (GE) ports;
performing a switching operation of the main and standby GE ports, setting the main GE port in a blocked state, and in the blocked state, the main GE port only forwarding a bridge protocol data unit (BPDU) message, and stopping learning a MAC address; and
enabling the standby GE port, setting the standby GE port in a forwarding state, and in the forwarding state, the standby GE port forwarding messages of all types, and learning the MAC address.

2. The main and standby switchover method for a network device according to claim 1, the step of setting the main GE port in a blocked state comprises:
setting a spanning tree protocol (STP) of the main GE port as a block mode, and enabling the main GE port to enter the blocked state; and
the step of setting a STP of the standby GE port as a forwarding state comprises: setting the STP of the main GE port as a forwarding mode, and enabling the main GE port to enter the forwarding state.

3. The main and standby switchover method for a network device according to claim 1, wherein after setting the STP of the main GE port in the blocked state, further comprising:
deleting all dynamic MAC addresses learnt by the main GE port.

4. A main and standby switchover apparatus for a network device, comprising:
a receiving unit, configured to: receive an interrupt signal indicating that a switchover needs to be performed for main and standby Gigabit Ethernet (GE) ports;
a first setting unit, configured to: set the main GE port in a blocked state, wherein in the blocked state, the main GE port only forwards a bridge protocol data unit (BPDU) message and stops learning a MAC address; and
a second setting unit, configured to: enable the standby GE port, and set the standby GE port in a forwarding state, wherein in the forwarding state, the standby GE port forwards messages of all types and learns the MAC address.

5. The main and standby switchover apparatus for a network device according to claim 4, wherein, the first setting unit is configured to: set a spanning tree protocol (STP) of the main GE port as a block mode, and enable the main GE port to enter the blocked state; and
the second setting unit is configured to: set the STP of the main GE port as a forwarding mode, and enable the main GE port to enter the forwarding state.

6. The main and standby switchover apparatus for a network device according to claim 4, further comprising:
a deleting unit, configured to: delete all dynamic MAC addresses learnt by the main GE port after the first setting unit sets the STP of the main GE port as the blocked state.

7. An optical network unit (ONU) device, comprising: a main Gigabit Ethernet (GE) port, a standby GE port and a CPU, further comprising:
a detection module, configured to: detect state information of the main GE port, and send an interrupt signal indicating that a switchover needs to be performed for main and standby GE ports to the CPU if a main and standby switchover needs to be performed for GE ports;
a exchanging chip, configured to: set the main GE port in a blocked state; enable the standby GE port, and set the standby GE port in a forwarding state;
wherein the CPU is configured to: control the exchanging chip to work according to the interrupt signal;
wherein in the blocked state, the main GE port only forwards a bridge protocol data unit (BPDU) message and stops learning a MAC address; and in the forwarding state, the standby GE port forwards messages of all types and learns the MAC address.

8. A network access system, comprising the optical network unit (ONU) device according to claim 7.
